(19) United States
(12) Patent Application Publication
(10) Pub. No.: US 2013/0311901 A1
(43) Pub. Date: Nov. 21, 2013

(54) OBJECT INTERACTION RECORDATION SYSTEM

(71) Applicant: BK-N Inc., Nepean (CA)

(72) Inventor: Stephane Michel Francois, Nepean (CA)

(73) Assignee: BK-N Inc., Nepean (CA)

(21) Appl. No.: 13/894,398

(22) Filed: May 14, 2013

Related U.S. Application Data
(60) Provisional application No. 61/646,977, filed on May 15, 2012.

(51) Int. Cl. G06F 3/0484

(52) U.S. Cl. CPC G06F 3/0484
USPC 715/753

(57) ABSTRACT

Methods and systems for recording interactions between a user and specific objects. An interaction recordation system first receives an indication from a user that an interaction is to be recorded. The system prompts the user for an identification of the object with which the user has interacted. After receiving this identification, the system can then prompt the user for more details regarding the object as well as details about the interaction, including the user's impressions, feedback, and opinions about the object. These various inputs are then uploaded to a server where they can be accessed by the user. At least some of these impressions and feedback can also be anonymously shared by the user with other users who might be interested in the same object. The object can be a location, a business, an item, an application, or anything which the user can use, purchase, visit, or interact with.

This non-provisional patent application relates to provisional patent application Ser. No. 61/646,977 filed on May 15, 2012

### TECHNICAL FIELD

The present invention relates to the creation of databases. More specifically, the present invention relates to methods and systems for creating and maintaining a database of interactions between a user and a variety of material and non-material objects.

### BACKGROUND OF THE INVENTION

The continuing computer revolution of the 2000s has provided users with unprecedented access to not only computing power but also to almost ubiquitous data storage.

This development provides users with the means to register and record their impressions and reactions to almost anything they encounter. Currently there are no available applications or software that easily allows a user to record their impressions regarding their interactions. Currently, users may write a blog or may record their feedback regarding restaurants on specific websites. However, these methods do not provide convenience nor do they provide ease of access. As well, these methods only provide the user with the capability to provide feedback or impressions regarding specific objects, interactions, or locations. None of these methods provide the flexibility to allow users to generate feedback or impressions regarding other, non-predetermined objects.

There is therefore a need for methods and systems which allow for ubiquitous and free-form or free-flowing feedback or interaction impression recordation for users.

### SUMMARY OF INVENTION

The present invention relates to methods and systems for recording interactions between a user and specific material and non-material objects. An interaction recordation system first receives an indication from a user that an interaction is to be recorded. The system prompts the user for an identification of the object with which the user has interacted. As part of the identification, the user can further identify the object using various technical means such as, for example, selecting it from a list, indicating the object on a map, scanning an identifier with a mobile device, or taking a picture of the object. After receiving this identification, the system can then prompt the user for details regarding the interaction, including the user's impressions, feedback, and opinions about the object. These various inputs are then uploaded to a server where they can be accessed by the user. At least some of these impressions and feedback can also be anonymously shared by the user with other users or object representatives who might be interested in the same object. The object can be a location, a business, an item, an application, or anything which the user can use, purchase, visit, or interact with.

In a first aspect, the present invention provides a method for registering an interaction between a user and an object, the method comprising:
a) receiving an indication that said user desires to register an interaction;
b) initiating a record for said transaction;
c) prompting said user for an identification of said object;
d) receiving an identification of said object;
e) prompting said user for feedback and interaction details regarding said object;
f) uploading record to server on a network
   wherein said method is practiced on a data processing device.

In a second aspect, the present invention provides a system for recording a user's interaction with an object, the system comprising:
a first user interface used by an application which executes on a mobile computing device, said user interface being for prompting a user for an identification of said object;
a second user interface used by said application, said second user interface being for prompting said user for said user's feedback and interaction regarding said object; and
a storage module used by said application, said module being for storing said identification and said feedback in a record in a server physically remote from said user.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of an environment on which the invention may be practiced;

FIGS. 2-8 are screenshots of one implementation of the invention; and

FIG. 9 is a flowchart detailing the steps in a method according to one aspect of the invention.

### DETAILED DESCRIPTION OF THE INVENTION

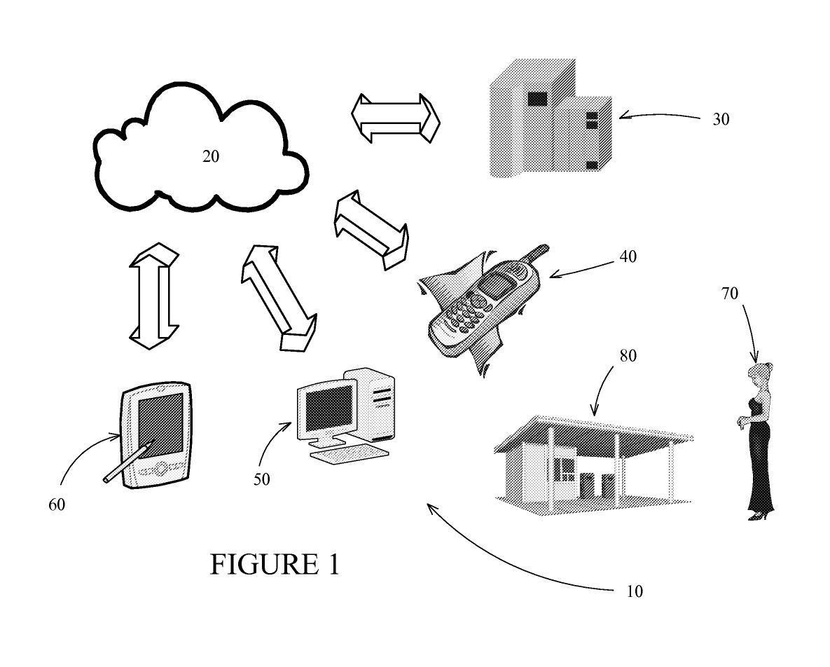

Referring to FIG. 1, a system 10 on which one aspect of the invention may be practiced is illustrated. The system 10 has a network 20 to which are connected a server 30 along with a mobile (smartphone) device 40, a desktop computer 50, and a tablet computing device 60.

The user 70 interacts with object 80 and, using the mobile device 40, creates a record of his interaction with the object 80. This record is then uploaded and stored in the server 30 by way of the network 20. The user can also use the desktop 50 or the tablet 60 to create more records and to access previously created records on the server 30.

The user 70 may also mark some of his previously created records or part of these previously created records for sharing. Once marked as such, these records or portions of records can be accessed by user 70 by, again, any of the various devices connected to the server 20 through the network 20.

It should be noted that multiple users may simultaneously use the system to create records of their interactions with various objects. This results in a database of records of interactions between various users and various objects. As noted above, some of these records or portions of these records may be shared by the users who created them with other users.

To facilitate the use of the service noted above, the system uses a website that users can log into. The website posts the records or portions of records that are publicly but anonymously shared by its users. Other users can, of course, view these records on the website. Non-users (ie non-registered users) may also use the website to view feedback or impressions that other users may have regarding objects which may be of interest to the non-users.

In one implementation, users can access the database to post or record their feedback or impressions by way of their Internet connected mobile device. As can be imagined, the mobile device can be a smartphone, a tablet computing device, or any other. If the user opts to not record any feedback or opinions about an interaction with the object, the database can serve as a note to the user that the interaction occurred. Of course, once the interaction has been recorded and uploaded to the server, the user may login and amend/add to the record of the interaction.

To record an interaction, the user first indicates that an interaction is to be recorded. This can be done by launching a specific application on the mobile device and initiating a new interaction record. The application then prompts the user for an identification of the object interacted with. The user then enters the identification of the object, whether the object be a place, item, business, location, or something else. Once the identification has been entered, the user may then be prompted for a location of the object. This location can be where the user is at that point in time, a previous location where the object is, where the object may have been purchased, or some other location. While the user may be prompted for the location, it is not necessary for the user to enter a location to proceed with the process. As well, the user may not even need to key in a location as GPS equipped mobile devices may use that capability to determine the user's current location. This current location can then be presented to the user as a possible location for the object. Alternatively, the user can simply key in the location using the mobile device's keyboard.

Once the user has been prompted for a location, the user may also be prompted for further identification of the object including a photograph of the object. This option can be easily integrated with the mobile device's camera. The user can be prompted to take an identifying photo of the object being reported on. Alternatively, the user may be prompted to tag an existing photo in the mobile device's photo library for the object.

In addition to the above means for identifying the object, the user may also enter other descriptions for the object. As an example, if the object is a consumer item, the user may indicate the brand, model, configuration, and price of the item. Other types of identification indicia may, of course, also be entered by the user.

After the user has identified the object, whether this is done through indicating the location, a photo, or a description of the object, the user can then enter his or her feedback, impressions, and thoughts regarding the object. This can be done through the application prompting the user for directed feedback concerning the object being interacted with. The application may provide the user with a sliding bar interface to indicate the user's thoughts on his or her satisfaction with any of the following:
the object,
the purchase of the object (if applicable),
the interaction with the object
the location of the object
condition of the object
reputation of the object
accessibility of the object
cost of the object
usability of the object
perceived value of the object
eco-friendliness of the object

Alternatively, the application may use radio buttons with predefined feedback options regarding the user's interaction with the object. As an example, the user may be provided with radio buttons for “satisfied”, “highly satisfied”, or “unsatisfied” to indicate the user's thoughts regarding the object's condition.

Other means for inputting the user's opinions, feedback, and impressions regarding the object may also be used.

In addition to a possible sliding bar interface or a radio button interface, the application may provide the user with space in which the user can enter free-form text as part of the record for his or her interaction with the object. The free form text can be marked by the user as being private or shared. If marked as private, only the user can access the record. If marked as shared, the text is anonymously shared with the rest of the users of the website or web service.

Similar to the above, any of the user's opinions, feedback, or thoughts that have been entered as part of the record for his or her interaction with the object may be marked by the user as being either private or public.

The above description notes a manual launching of the specific application for recording user feedback regarding an interaction. Alternatively, once an interaction has finished, a mobile device can automatically launch the application, insert the relevant identification, and prompt the user for his or her feedback regarding the interaction. As an example, the user may use his mobile device to purchase an item or to pay for a service. At the termination of the transaction, the mobile device can launch the application, add the relevant identification for the object which was the subject of the transaction, and prompt the user for feedback regarding the object. As another alternative, the user may scan a bar code or enter a code to signal the end of a transaction or to identify an object. Once the code has been entered, the mobile device may automatically launch the application as noted above. Once the user has entered the feedback, the process continues as described herein. This variant saves the user a number of steps for providing feedback about the object.

To help users of the website or web service find relevant feedback or impressions on specific objects, the website noted above may be equipped with a search function to find objects and feedback regarding these objects.

To further assist users of the website, users who leave feedback or impressions regarding their interaction with objects may choose to associate themselves with either the specific objects or with a specific class or type of objects. As an example, if user A records an interaction with a specific brand of digital music players, that same user A can associate himself with that brand or with that type of music player. Thus, any other users of the website, when they look for feedback regarding that brand of music players can access other feedback left by user A.

It should be noted that the businesses which produced or sold the objects (or which are the objects themselves) may also have access to the users' comments or feedback. An aggregate or aggregation of user feedbacks and comments regarding the business may be produced so users and businesses may see, at a glance, the overall impression from users about the business. This allows the businesses to receive feedback from their customers without being targeted by a specific user. The businesses can then work to improve their services/products based on user feedback. Of course, this user feedback, like all shared user feedback/comments, are anonymous. A user can then safely voice his or her opinions on an object, whether it is a business, a purchasable item, a service, or something else with complete anonymity. Of course, to receive this type of feedback from its customers, a business may be charged a fee by the operators of the website or web service.

The business that signs up to receive anonymized feedback may also receive the benefit of a direct line to their customers by way of the website. Since users who leave feedback can self-identify as being associated with the particular object being interacted with, the listing of users who self-identify can be anonymously contacted by the business for promotions, updates, and bulletins regarding the object. Of course, the business would not have access to the identities of the users. The business would have the opportunity to contact these users by sending their communication to a common email or a common posting address. The communication would then be distributed by the website backend to the various users who have self-identified with the object. Again, depending on the configuration of the system and on the operators of the website, a business may need to purchase or pay for this capability to directly contact their customers, albeit anonymously. Such a direct communications link between a business and its customers can be used to provide information to customers and fans. The information provided can run the gamut from recalls and warnings relating the object, to promotional events, customer appreciation communications, discounts, limited time offers, etc.

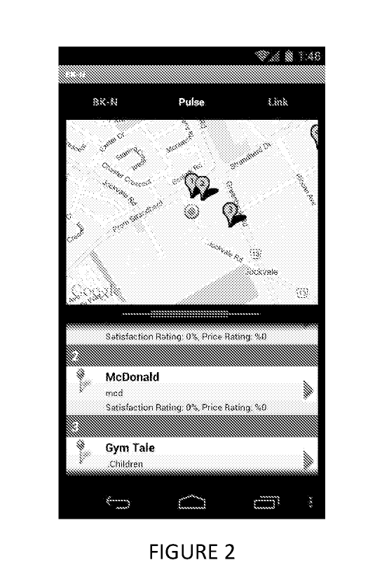

Referring to FIG. 2, a screenshot of an implementation of one aspect of the invention is illustrated. FIG. 2 shows a screenshot that locates where the user is based on the smartphone's GPS coordinates. As well, once the user's location has been determined, the system determines if there are any objects or locations nearby which have been interacted with by other users. The pins in the user interface show that there are three objects near the user. A summary of the features/characteristics of the nearby objects are also presented to the user. As an example, a branch of McDonald's™ is near the user and the aggregate feedback relating to that branch is provided.

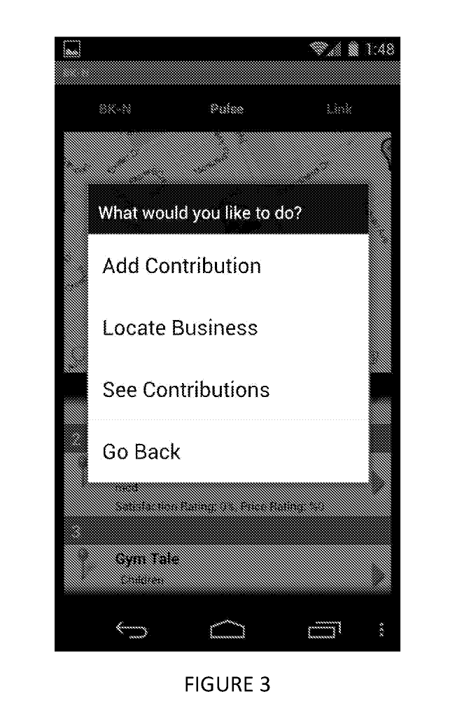

Referring to FIG. 3, a screenshot of a prompt given to a user is illustrated. The prompt provides the user with a number of options—adding a contribution (ie creating a new record of an interaction), locating a business (ie geographically tagging a location object), or viewing feedback or comments posted by other users.

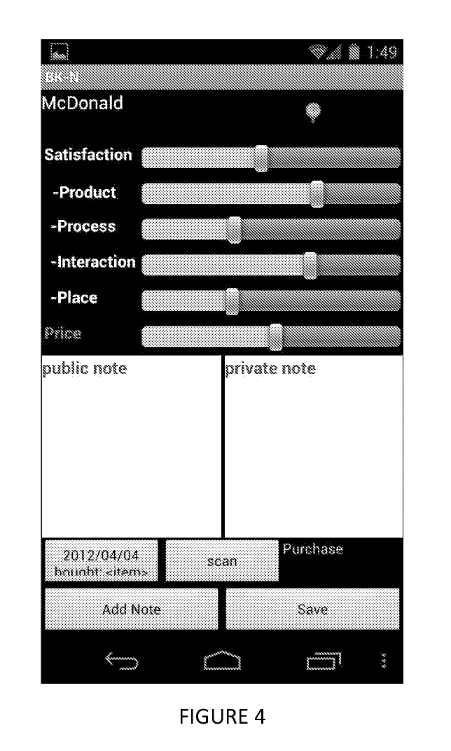

Referring to FIG. 4, a screenshot of a feedback/comment entry user interface is illustrated. The user can provide feedback or comments regarding their interaction with an object using this embodiment of the invention. As can be seen, there is a sliding bar relating to the user's overall satisfaction with the object (in this case a McDonald's™ restaurant). Also provided are sliding bars to rate the product at the location, the process which the user has to undergo, the interaction with the staff, and the physical place (ie the overall condition of the location) itself. The user may also use the sliding bar to rate the overall price paid for the product/experience. Should the user wish, a public note or feedback can also be entered. From the above, it should be clear that the public note is accessible by the users of the website. A user may also wish to enter a private note regarding the object. Of course, this private note is not accessible to anyone except the user. A save button at the bottom, when activated, will save the record of the user's transaction with the object.

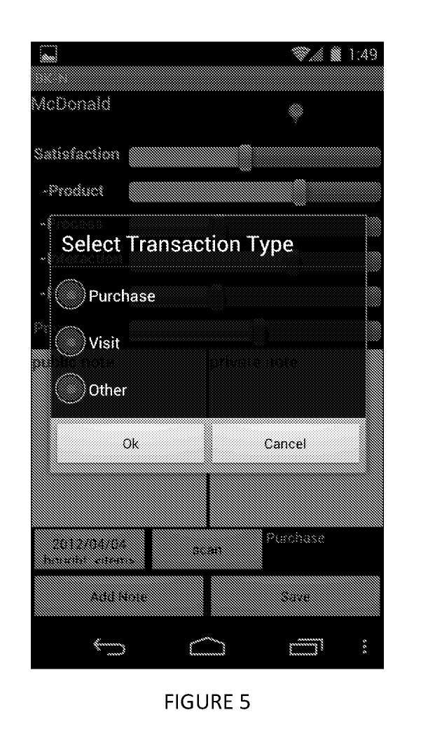

As a further detail regarding the user's interaction with the object, FIG. 5 illustrates a user interface where the user may categorize the interaction with the object. The user may categorize the interaction as a purchase (ie the user has purchased the object or has purchased something at the object/location), a visit (ie the user merely visited the premises), or some other uncategorized interaction.

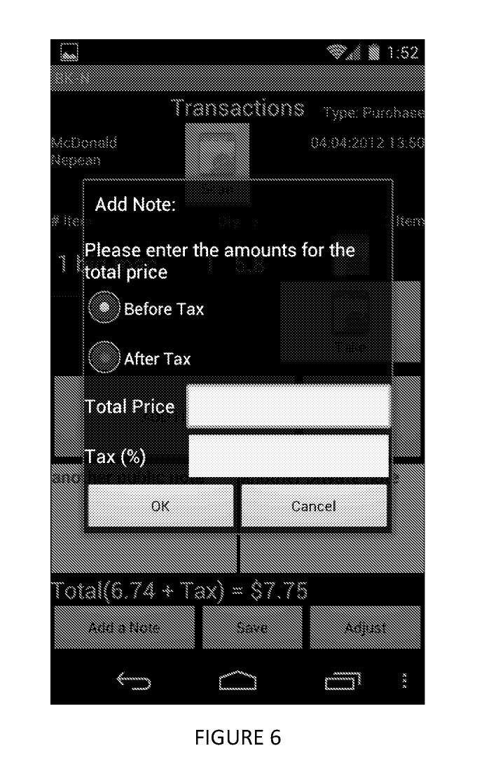

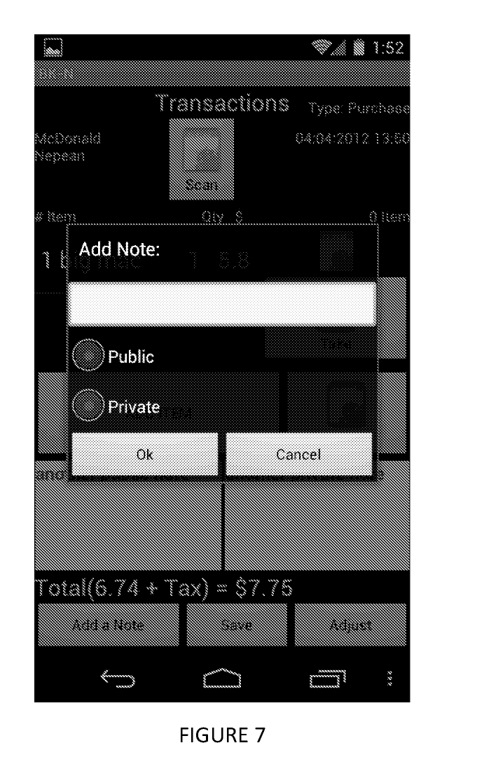

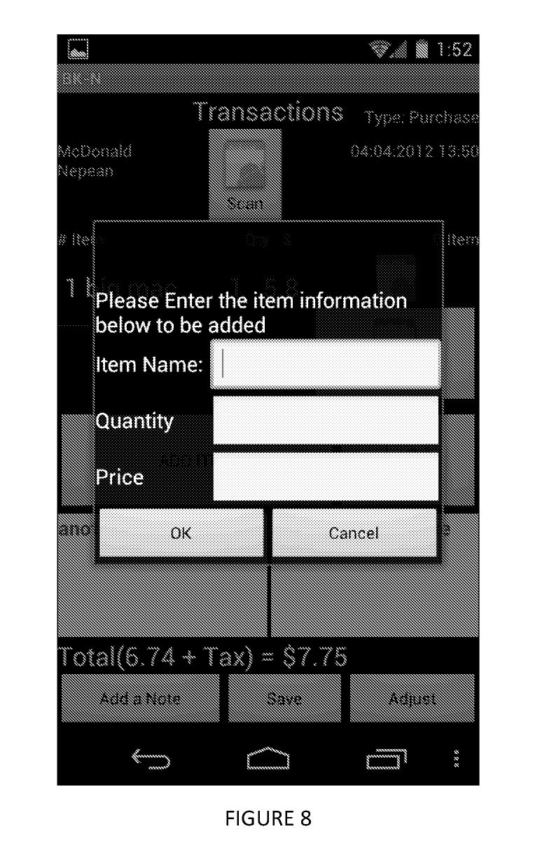

The user may also drill down into the details of his or her interaction using, as an example, the user interfaces in FIGS. 6-8. The user interface in FIG. 6 allows the user to enter the total price for the overall transaction the user may have had regarding the object. As an example, if the object is a restaurant, the user may enter the price for the visit. Similarly, the user may enter the price for the overall shopping trip to a store if the store is the object being interacted with. The user may also wish to append a note (whether public or private) to each and every item purchased or otherwise interacted with at the location/object (see FIG. 7). Finally, the user may wish to enter a description, along with quantity, for each and every item purchased or otherwise interacted with at a specific location. The user interface in FIG. 8 may be used to enter details for the different items purchased at a specific location.

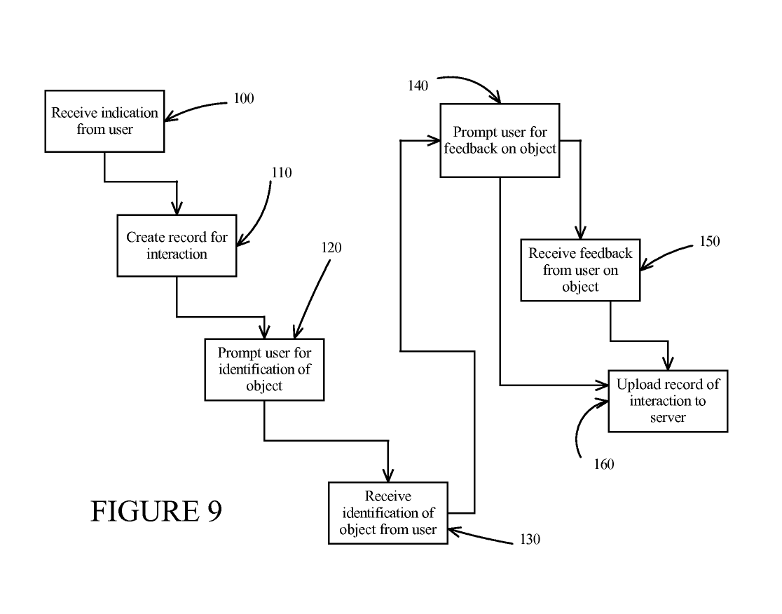

According to another aspect of the invention, there is provided a method of recording or registering an interaction between a user and an object. The method is outlined in the steps shown in the flowchart of FIG. 9. The method starts at step 100, that of the system receiving an indication from the user that the user wants to record an interaction with an object. Once this indication is received, the system then creates a record for the interaction with a particular object (step 110). Once the record has been created, the system then prompts the user for an identification of the object (step 120). The user then enters an identification of the object (step 130). The identification may be as simple as the name of the object or be a multi-level identification which could include any of the following: date, time, price, location, quantity, brand, UPC code, manufacturer code, serial number, lot number, color, option, etc., etc.

Once the identification has been entered, whether it be a detailed identification or a bare-bones name, the system can prompt the user for feedback or comments regarding the interaction with the object (step 140). The user could enter this feedback (step 150) and the interaction record, with the feedback and the identification, then is uploaded to a server for storage (step 160). Alternatively, the user could ignore the prompts and simply upload the record, with the identification, to the server (step 160).

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g. “C”) or an object-oriented language (e.g. “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A method for registering an interaction between a user and an object, the method comprising:
a) receiving an indication that said user desires to register an interaction;
b) initiating a record for said transaction;
c) prompting said user for an identification of said object;
d) receiving an identification of said object;
e) prompting said user for feedback and interaction details regarding said object;
f) uploading record to server on a network.
wherein said method is practiced on a data processing device.

2. A method according to claim 1 wherein said feedback regarding said object comprises feedback relating to at least one of
quality
quantity
value
interaction
place and surrounding
physical aspect
satisfaction
process
useability

3. A method according to claim 1 wherein said object comprises at least one of:
a purchasable item;
a location;
a service;
a business;
governmental services,
associations,
a public event
private object of users type.
a public performance
a speech by a public figure
a public communication from a public figure
a motion picture
a song
a quote
an educational course
a public meeting
a religious event

4. A method according to claim 1 wherein said method further comprises receiving said feedback from said user.

5. A method according to claim 1 wherein said method further comprises the step of prompting said user for more details regarding said interaction.

6. A method according to claim 4 wherein at least a portion of said feedback is anonymously shared with users of a specific feedback website.

7. A method according to claim 1 further including receiving notes from said user regarding said interaction.

8. A method according to claim 1 wherein said feedback relates to said user's experience with said object.

9. A method according to claim 1 wherein said object is a retailer and said feedback relates to a specific user experience with said retailer.

10. A method according to claim 1 further including the step of receiving from said user details regarding at least one item purchased at said retailer.

11. A method according to claim 1 wherein said object is a restaurant and said feedback relates to a specific user experience with said restaurant.

12. A method according to claim 11 further including the step of receiving from said user details regarding at least one item purchased at said restaurant.

13. A method according to claim 1 wherein said feedback and interaction details are accessible to said user after details are stored in a database.

14. A method according to claim 1 wherein said feedback and interaction details are accessible to other users only if said user who entered said details share said details with said other users.

15. A system for recording a user's interaction with an object, the system comprising:
a first user interface used by an application which executes on a mobile computing device, said user interface being for prompting a user for an identification of said object;
a second user interface used by said application, said second user interface being for prompting said user for said user's feedback regarding said object; and
a storage module used by said application, said module being for storing said identification and said feedback in a record in a server physically remote from said user.

16. A system according to claim 15 wherein said second user interface comprises a section using at least one of:
sliding bars
radio buttons
free form text
for users to enter feedback regarding said object.

17. Computer readable media having encoded thereon computer executable instructions for implementing a method for registering an interaction between a user and an object, the method comprising:
a) receiving an indication that said user desires to register an interaction;
b) initiating a record for said transaction;
c) prompting said user for an identification of said object;
d) receiving an identification of said object;
e) prompting said user for feedback and interaction details regarding said object;
f) uploading record to server on a network.
wherein said method is practiced on a data processing device.

18. An invention according to the attached text and figures.
